(19) United States
(12) Patent Application Publication
(10) Pub. No.: US 2014/0346943 A1
(43) Pub. Date: Nov. 27, 2014

(54) DISCHARGE LAMP

(71) Applicants: Seong Jin Kang, Seoul (KR); Seong Seok Kang, Seoul (KR)

(72) Inventors: Seong Jin Kang, Seoul (KR); Seong Seok Kang, Seoul (KR)

(21) Appl. No.: 14/456,088

(22) Filed: Aug. 11, 2014

Related U.S. Application Data
(63) Continuation of application No. PCT/KR2013/001065, filed on Feb. 12, 2013.

(30) Foreign Application Priority Data
Feb. 10, 2012 (KR) 10-2012-0013783

(51) Int. Cl. H01J 61/52; H01J 61/34

(52) U.S. Cl. CPC H01J 61/523; H01J 61/34
USPC 313/22; 313/27

(57) ABSTRACT

A discharge lamp includes a discharge tube, a stabilizer housing provided in the inner space that is defined by the discharge tube, the stabilizer housing containing a stabilizer therein, a cover surrounding the discharge tube; a base connected to the stabilizer housing, and a heat insulating means. The heat insulating means prevents the heat of the discharge tube from being transferred to the stabilizer.

### REFERENCE TO RELATED APPLICATIONS

This is a continuation of pending International Patent Application PCT/KR2013/001065 filed on Feb. 12, 2013, which designates the United States and claims priority of Korean Patent Application No. 10-2012-0013783 filed on Feb. 10, 2012, the entire contents of which are incorporated herein by reference.

### FIELD OF THE INVENTION

The present invention relates to a discharge lamp.

### BACKGROUND OF THE INVENTION

Generally, discharge lamps are widely used in a variety of illuminating facilities. The configuration of a discharge lamp includes a transparent discharge tube, which is made of a transparent material such as glass or quartz, and a stabilizer, which supplies power in order to drive the discharge tube. In the meantime, a discharge gas, such as mercury steam and buffer gas, is contained inside discharge tubes in order to generate electric discharge.

Discharge lamps operate as follows. When power is supplied to the discharge tube through the stabilizer from the outside, discharge gas inside the discharge tube generates plasma as a result of electrostatic discharge, and infrared radiation, visible light, or the like is emitted from the plasma.

A variety of discharge lamps has been developed to date, including a bulb-type discharge lamp that can be fitted into “a socket for an electric bulb” for use. However, the bulb-type discharge lamp is configured such that its length is very long compared to an incandescent lamp. Therefore, its use is limited although it has a relatively longer lifetime and higher efficiency compared to those of the incandescent lamp.

In order to solve such a problem, “a compact discharge lamp” was proposed according to Korean Patent No. 10-0492938. The compact discharge lamp has a discharge tube, which extends a predetermined length, and which is bent, such that a space is defined therein. A stabilizer housing is provided in the space in order to reduce the entire length and volume of the discharge lamp. However, a problem with this compact discharge lamp is that heat generated by the discharge lamp is directly transferred to the stabilizer so that the temperature of the stabilizer rapidly increases to a very high temperature.

Furthermore, in the case in which an incandescent lamp of the related art is replaced with a cover-type fluorescent lamp, demands are made for various types of lamps as was also the case of incandescent lamp. For example, there are demands made upon the shape, such as an A type, which is a traditional shape of incandescent lamps, a G type, which has an overall circular shape, an R type, which has a reflector therein, and a Par type. There is also a demand for a variety of shapes, such as cover-type or bulb-type fluorescent lamps, to be provided.

However, although the related art provides similar shapes in response to the above-mentioned demands for a variety of shapes, there are problems in that the overall volume increases, dull and stout configurations are provided, and light is not emitted toward the lower portion in which a stabilizer housing, if any, is provided. In addition, when a cover is provided, the temperature of the discharge tube inside the cover may excessively increase. This may also increase the temperature of the stabilizer, thereby reducing longevity. Furthermore, indium-based amalgam for high-temperature use must be used in order to properly adjust the vapor pressure of hot mercury, which is increased by the high temperature of the discharge tube inside the cover. However, the amalgam for high-temperature use has a problem in that it is not easy to light the lamp because of the low vapor pressure at room temperature. Accordingly, in order to solve this problem, auxiliary amalgam, which is produced by applying a thin layer of indium on a molybdenum matrix having the form of a thin sheet or net, must be used, thereby increasing the cost of manufacture.

### SUMMARY OF THE INVENTION

Accordingly, the present invention has been made keeping in mind the above problems occurring in the related art, and the present invention is intended to propose a discharge lamp that can minimize the amount of heat that is emitted from a discharge tube from being transferred to a stabilizer housing while reducing the length and volume of the discharge lamp.

The present invention is also intended to propose a discharge lamp which can reduce the time and cost required to assemble the discharge lamp while reducing the length and volume of the discharge lamp.

The present invention is also intended to propose a discharge lamp, which exhibits excellent performance, such as brightness and lighting speed, which are superior to those of discharge lamps of the related art, without having to use expensive amalgam for high-temperature use and auxiliary amalgam.

In order to achieve the above object, according to one aspect of the present invention, there is provided a discharge lamp that includes a discharge tube; a stabilizer housing provided in the inner space that is defined by the discharge tube, the stabilizer housing containing a stabilizer therein; a cover surrounding the discharge tube; a base connected to the stabilizer housing; and a heat insulating means. The heat insulating means prevents the heat of the discharge tube from being transferred to the stabilizer. Here, the heat insulating means may include a heat insulating housing, which surrounds at least a part of the stabilizer housing such that at least one air gap is formed between the discharge tube and the stabilizer housing. Furthermore, at least a part of the heat insulating housing and at least a part of the stabilizer housing may be integrally formed.

The configuration of the heat insulating housing will now be described. Here, the heat insulating housing may include a first heat insulating housing formed integrally with the stabilizer housing and a second heat insulating housing connected to the first heat insulating housing. The stabilizer housing may include a first stabilizer housing connected to the base and a second stabilizer housing connected to the first stabilizer housing. Accordingly, the heat insulating housing includes a first heat insulating housing formed integrally with the first stabilizer housing and a second heat insulating housing connected to the first heat insulating housing.

In order to minimize the heat transferred from the discharge tube to the stabilizer housing, the discharge lamp may further include an air circulating means. The air circulating means discharges air from the space between the heat insulating housing and the stabilizer housing to the outside and introduces external air to the space between the heat insulating housing and the stabilizer housing. The air circulating means may include a first opening formed in the portion of the heat insulating housing that is adjacent to the base and a second opening formed in another portion of the heat insulating housing, the second opening communicating with the outside. The cover may have a communication-hole communicating with the second opening.

In addition, the discharge lamp may further include a guide rib on at least one of the cover and the heat insulating housing. The guide rib guides the flow of air between the second opening and the communication-hole. In this case, the guide rib may have a through-hole through which the discharge tube extends. The discharge lamp may have a first fixing portion formed along at least a portion of the through-hole, the first fixing portion fixing the discharge tube; and a second fixing portion formed in the stabilizer housing, the second fixing portion extending a predetermined length corresponding to the first fixing portion, thereby fixing the discharge tube. One end of the second fixing portion may become narrower in the direction toward the distal tip thereof, such that the second fixing portion is bent by a predetermined angle when fixing the discharge tube, securely fixing the discharge tube. Furthermore, the discharge lamp may further have a third fixing portion on a portion of the heat insulating housing, the third fixing portion also fixing the discharge tube. The holder may be pressed and fixed to the heat insulating housing.

The discharge lamp may further have a shield rib formed in the through-hole, the shield rib preventing light from the discharge tube from being directly emitted to the outside. In addition, the shield rib may have an engagement-hole, and the stabilizer housing may have an engagement boss corresponding to the engagement-hole, such that the cover can be more securely assembled.

In addition, the cover may include a first cover and a second cover, which are selectively connected to each other. For example, the cover may include the first cover, which is connected to a portion that is adjacent to the base, and the second cover, which is connected to one end of the first cover. In this case, the first diameter of the joint that connects the first cover and the second cover to each other is greater than the second diameter of the joint that connects the first cover to the base. This consequently makes it possible to insert the discharge tube into the cover, when the diameter of the discharge tube is greater than the diameter of the joint between the second cover and the base.

According to embodiments of the invention, the discharge lamp extends a predetermined length, and the stabilizer housing is provided inside the bent discharge lamp, such that the length and volume of the entire discharge lamp can be reduced. The heat insulating housing is provided outside the stabilizer housing, such that a separate air gap is formed between the stabilizer housing and the heat insulating housing, thereby minimizing the amount of heat emitted from the discharge tube that is transferred to the stabilizer housing. Furthermore, the first opening communicating with the outside is formed in one portion of the heat insulating housing and the second opening communicating with the outside via the cover is formed in the other side of the heat insulating housing, such that the external air is circulated along the space between the stabilizer housing and the heat insulating housing, thereby preventing the heat emitted from the discharge tube from being transferred to the stabilizer housing. Accordingly, the discharge lamp can be reliably operated when the discharge lamp has been turned on for a long time.

In addition, since at least a part of the heat insulating housing and at least a part of the stabilizer housing are formed integrally, the discharge lamp can be easily assembled. In particular, the portion of the heat insulating housing and the portion of the stabilizer housing that are adjacent to the base can be formed integrally, thereby reducing the assembly time.

Furthermore, the discharge tube can be more reliably fixed using a plurality of fixing portions instead of fixing it using an adhesive. Since bonding and curing processes are omitted, it is possible to reduce the operation time and significantly reduce the space, facilities and personnel required for the operation.

In the meantime, dividing the cover into the first cover and the second cover facilitates assembly. Since the diameter of the joint that connects the first and second covers to each other is greater than the diameter of the joint that connects the second cover to the base, it is possible to insert the discharge tube into the cover, when the diameter of the discharge tube is greater than the diameter of the joint between the second cover and the base.

Furthermore, a first opening communicating with the outside is formed in one portion of the heat insulating housing and the second opening communicating with the outside via the cover is formed in the other side of the heat insulating housing, such that a portion of the discharge tube is provided in the space that communicates with the cover, that is, the space in which the second opening is connected to the cover. This consequently enables the temperature of the corresponding portion of the discharge tube to remain similar to the temperature of the outer cover and thus act as a cold point. Accordingly, it is possible to obtain the improved effects furnished by using inexpensive amalgam for low-temperature use without using amalgam for high-temperature use, which was inevitably used in cover-type discharge lamps of the related art, and auxiliary amalgam (e.g., indium-based auxiliary amalgam having the form of a thin sheet or net), which was used to solve the problem of the use of the amalgam for high-temperature creating a slower lighting speed of the discharge tube.

### BRIEF DESCRIPTION OF THE DRAWINGS

The above and other objects, features and further advantages of the present invention will be more clearly understood from the following detailed description when taken in conjunction with the accompanying drawings, in which:

FIG. 1 is a perspective view showing a discharge lamp according to an exemplary embodiment of the invention;

FIG. 2 is a cross-sectional perspective view of the discharge lamp shown in FIG. 1;

FIG. 3 is a cross-sectional side view of the discharge lamp shown in FIG. 1;

FIG. 4 is a perspective view of the discharge lamp shown in FIG. 1 from which the cover has been removed;

FIG. 5 is a perspective view of the discharge lamp shown in FIG. 4 from which the discharge tube is removed;

FIG. 6 is a cross-sectional perspective view of the discharge lamp shown in FIG. 5;

FIG. 7 is a cross-sectional perspective view of the second cover; and

FIG. 8 is a cross-sectional perspective view of the first cover.

### DETAILED DESCRIPTION OF THE INVENTION

Reference will now be made in greater detail to preferred embodiments of the invention, examples of which are illustrated in the accompanying drawings. Wherever possible, the same reference numerals will be used throughout the drawings and the description to refer to the same or like parts.

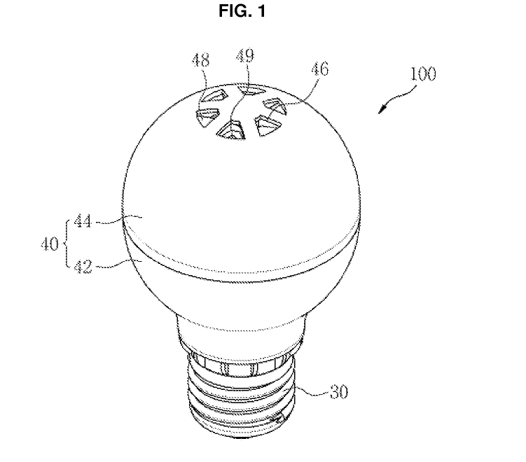

FIG. 1 is a perspective view showing a discharge lamp 100 according to an exemplary embodiment of the invention.

Referring to FIG. 1, a discharge lamp 100 may include a discharge tube 10, which emits light. In this embodiment, the discharge tube 10 extends a predetermined length, and is bent a predetermined number of times, such that a containing space is defined therein. Although FIG. 1 shows a spirally bent discharge tube 10, this is not intended to be limiting. Any shape that can define the inner space therein is available.

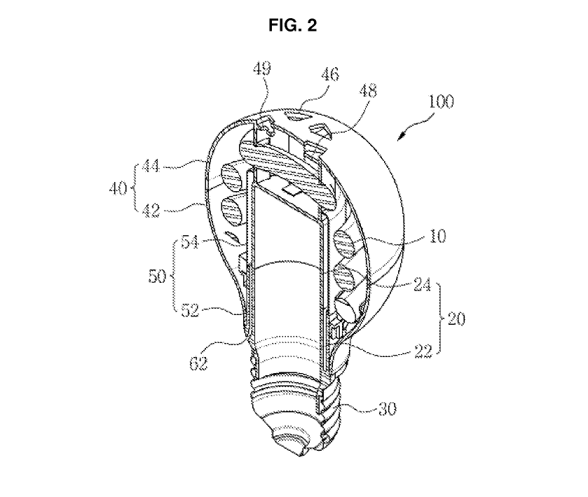

A stabilizer housing 20 (refer to FIG. 2) may be provided inside the space, which is defined inside the discharge tube 10. The stabilizer housing 20, which is provided inside the discharge tube 10, contains therein a stabilizer, which is designed to supply power to the discharge tube 10. Therefore, when the discharge tube 10 and the stabilizer housing 20 are coupled together, the volume of the resultant structure is determined by the outer volume of the stabilizer tube 10, thereby reducing the entire volume of the structure. A base 30 is connected to the stabilizer housing 20. For example, as shown in the figure, the base 30 may be provided on one end of the stabilizer housing 20. The base 30 is connected to a socket (not shown) or the like in order to supply power from an external power supply to the above-described stabilizer.

In addition, the discharge lamp 100 may include a cover 40, which is designed to surround the discharge tube 10. The cover 40 is made of a transparent material which allows light emitted from the discharge tube 10 to pass through it. In addition, the cover 40 may be provided by two or more members in order to facilitate assembly. The cover 40 will be described in more detail later.

As described above, the stabilizer is provided inside the stabilizer housing 20, and includes electronic components, such as transistors and electrolytic capacitors, in order to supply power to the discharge tube 10. Here, the lifetime and stability of such electronic components are closely related to temperature. For example, the lifetime of an electrolytic capacitor, the characteristics of which are dependent on an electrolyte, decreases to approximately half when temperature increases 10 degrees. In addition, electronic components such as semiconductor devices may malfunction when the temperature increases by a predetermined number of degrees or more. In particular, when electric power is instantaneously stopped or voltage is changed abruptly in the state having a relatively high temperature, semiconductor devices or electrolytic capacitors may malfunction. Therefore, when a compact discharge lamp is implemented by reducing the volume of the discharge lamp as in this embodiment, it is required to prevent or minimize the heat emitted from the discharge tube from being transferred to the stabilizer and/or stabilizer housing. For this, the discharge lamp 100 of this embodiment includes a heat insulating means, which prevents the heat of the discharge tube 10 from being transferred to the stabilizer housing 20. The heat insulating means will be described in detail as follows.

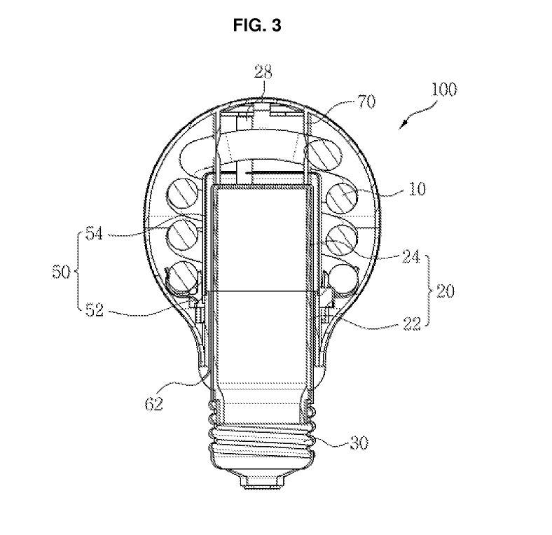

FIG. 2 is a cross-sectional perspective view of the discharge lamp shown in FIG. 1, and FIG. 3 is a cross-sectional side view of the discharge lamp shown in FIG. 1.

Referring to FIG. 2 and FIG. 3, the above-described heat insulating means may be provided such that a separate air gap is formed between the discharge tube 10 and the stabilizer housing 20. Since the discharge tube 10 surrounds the cover 40, the air gap (hereinafter, referred to as the “first air gap”) is present between the discharge tube 10 and the cover 40. Thus, heat that is emitted from the discharge tube 10 is transferred through the first air gap. In order to prevent the heat transfer through the first air gap, another air gap (hereinafter, referred to as a “second air gap”) together with the first air gap may be provided such that they surround the stabilizer housing. Therefore, the heat insulating means of this embodiment may be configured such that it includes the first air gap and the separate second air gap between the discharge tube 10 and the stabilizer housing 20. For this, the heat insulating means may be provided with a heat insulating housing 50, which is configured such that it surrounds at least a part of the stabilizer housing 20, thereby forming at least one air gap between the discharge tube 10 and the stabilizer housing 20.

The heat insulating housing 50 is provided such that it surrounds at least a part of the stabilizer housing 20, and preferably, as much of the surface of the stabilizer housing 20 as possible. Due to this configuration, the separate air gap, i.e. the second air gap, may be provided between the discharge tube 10 and the stabilizer housing 20 in order to prevent the heat that is emitted from the discharge tube 10 from being directly transferred to the stabilizer housing 20. As a result, the heat insulating housing 50, which is configured as above, can form a triple heat insulating structure that includes the heat insulating housing 50, the second air gap and the stabilizer housing 20 in order to minimize heat transfer.

The heat insulating housing 50, which is provided separate from the stabilizer housing 20, may increase the time and cost of assembly, compared to when the heat insulating housing 50 is not provided. In order to solve this problem, in this embodiment, at least a part of the heat insulating housing 50 and a part of the stabilizer housing 20 may be formed integrally. Since the part of the heat insulating housing 50 and the part of the stabilizer housing 20 are formed integrally, it is possible to remove the inconvenience of separately fabricating the heat insulating housing 50 and the stabilizer housing 20 and then assembling them together.

Specifically, the stabilizer housing 20 may include a first stabilizer housing 22, which is connected to the base 30, and a second stabilizer housing 24, which is selectively connected to the first stabilizer housing 22. Here, after the first stabilizer housing 22 is connected to the base 30, the second stabilizer housing 24 is connected to the first stabilizer housing 22.

In addition, the heat insulating housing 50 may include a first heat insulating housing 52, which is formed integrally with the stabilizer housing 20, and a second heat insulating housing 54, which is connected to the first heat insulating housing 52. In particular, since at least a part of the heat insulating housing 50 is formed integrally with the stabilizer housing 20, the first heat insulating housing 52 may be formed integrally with the first stabilizer housing 22. That is, the first stabilizer housing 22, which is connected to the base 30, is formed integrally with the first heat insulating housing 52. According to this structure, it may be very simple to assemble the heat insulating housing 50 and the stabilizer housing 20 together. This is because the assembly is accomplished by connecting together the first stabilizer housing 22, which is connected to the base 30, and the first heat insulating housing 52, and then connecting the second stabilizer housing 25 and the second heat insulating housing 54 to the respective upper portion of the first stabilizer housing 22 and the first heat insulating housing 52.

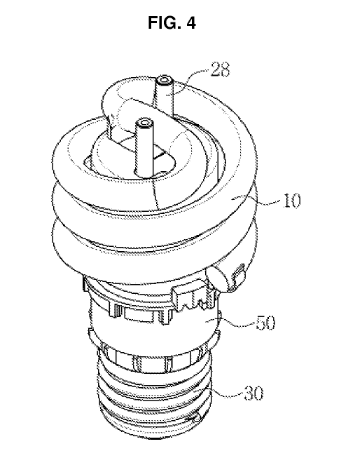

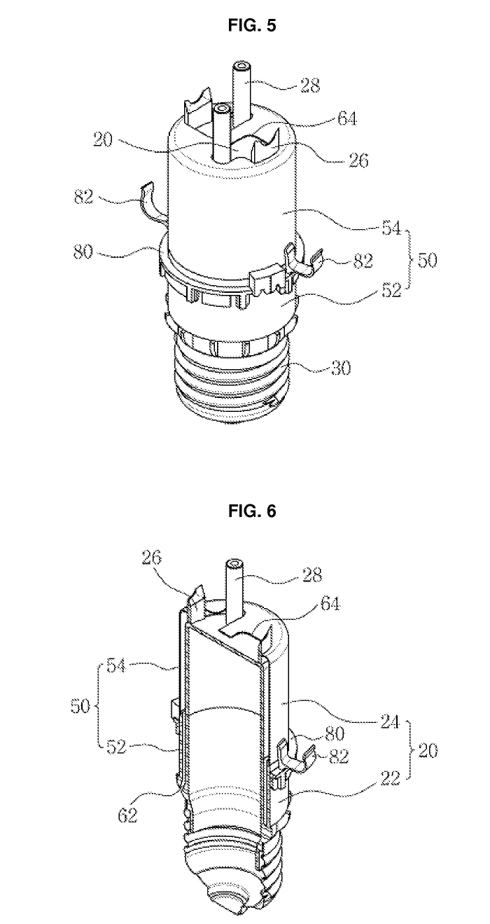

FIG. 4 is a perspective view of the discharge lamp shown in FIG. 1 from which the cover is removed, and FIG. 5 is a perspective view of the discharge lamp shown in FIG. 4 from which the discharge tube has been removed.

Referring to FIG. 4 and FIG. 5, as described above, the discharge tube 10 extends a predetermined length, and is bent a predetermined number of times, such that the stabilizer housing 20 is provided therein. Consequently, as shown in the figures, when the discharge tube 10 and the stabilizer housing 20 are coupled to each other, the volume of the resultant structure is determined by the outer volume of the discharge tube 10, thereby reducing the entire volume of the structure.

As described above, the second air gap that is formed by surrounding the stabilizer housing 20 with the heat insulating housing 50 may reduce the heat that is transferred from the discharge tube 10. However, the effect of preventing heat transfer may be insufficient when the heat insulating housing 50 simply surrounds the stabilizer housing 20. This is because, when the separate air gap is formed using the heat insulating housing 50, the air gap (second air gap) between the heat insulating housing 50 and the stabilizer housing 20 may also be warmed by the heat from the discharge tube 10, and thus the heat may be transferred to the stabilizer housing 20.

Accordingly, the discharge lamp 100 of this embodiment may also include a separate heat insulating means for preventing heat from being transferred from the discharge tube 10, in addition to the heat insulating housing 50. This separate heat insulating means may be implemented as an air circulating means that discharges air from the space between the heat insulating housing 50 and the stabilizer housing 20 to the outside and introduces air from the outside into the space between the heat insulating housing 50 and the stabilizer housing 20. Since the air is discharged from between the heat insulating housing 50 and the stabilizer housing 20 to the outside and the external air is introduced into the space between the heat insulating housing 50 and the stabilizer housing 20, the heated air in the space between the heat insulating housing 50 and the stabilizer housing 20 can be replaced with the external air, thereby preventing heat transfer.

FIG. 6 is a cross-sectional perspective view of the discharge lamp shown in FIG. 5. The air circulating means will be described as follows, while making reference to FIG. 2 and FIG. 6.

The air circulating means may include a first opening 62, which is provided in one portion of the heat insulating housing 50 that is adjacent to the base 30, such that it communicates with the outside, and a second opening 64, which is provided in the other portion of the heat insulating housing 50, such that it communicates with the outside via the cover 40. That is, the first opening 62 is provided in the portion of the first heat insulating housing 52 that is adjacent to the base 30, such that it communicates with the outside. Furthermore, the second opening 64 is provided in the other side of the heat insulating housing 50, i.e. in the upper portion of the heat insulating housing 50 in the figure, such that it communicates with the outside via the cover 40. The number of the second openings 64 may be at least one, and as shown in the figure, be at least two.

The cover 40 may also have a communication hole 46, which communicates with the second opening 64. That is, the space inside the heat insulating housing 50 communicates with the outside through the second opening 64 and the communication hole 46 of the cover 40. In this case, as shown in the figure, there is a predetermined space between the cover 40 and the heat insulating housing 50. Therefore, there is also required a guide, by which the air that is discharged through the second opening 64 of the heat insulating housing 50 is guided to exit through the communication hole 46, or the air that is introduced through the communication hole 46 of the cover 40 is guided to flow toward the second opening 64. For this, a guide rib 70, which guides the flow of air between the second opening 64 and the communication hole 46, may also be provided in at least one of the cover 40 and the heat insulating housing 50. Although it is illustrated in the figure that the guide rib 70 is provided in the cover 40, this is not intended to be limiting. An extension from the heat insulating housing 50 toward the cover 40 may also be formed.

As described above, since the air circulating means is used to discharge the air between the heat insulating housing 50 and the stabilizer housing 20 to the outside and to supply the external air to the space between the heat insulating housing 50 and the stabilizer housing 20, it is possible to maintain the temperature of the discharge tube 10 substantially similar to the temperature outside the cover 40 even though the discharge lamp of this embodiment has the cover. Accordingly, the brightness of the discharge tube 10 can rapidly reach normal, and the mercury steam inside the discharge tube 10 can be adjusted to a suitable temperature. This can curtail the necessity for expensive materials, such as amalgam for high-temperature use, auxiliary amalgam or the like, thereby reducing the cost of manufacture.

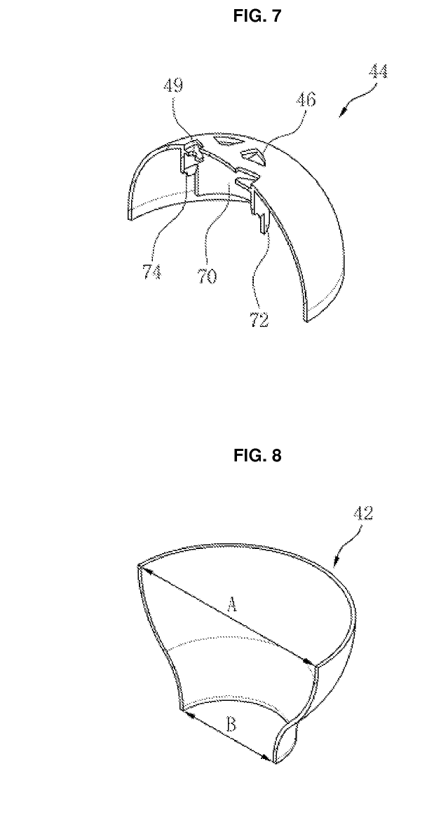

FIG. 7 is a cross-sectional perspective view of a second cover 44. With reference to FIG. 7, the guide rib 70 will be described as follows.

The above-mentioned guide rib 70 may extend a predetermined length from the cover 40 (second cover 44) toward the heat insulating housing 50 such that it surrounds the second opening 64 of the heat insulating housing 50 and the communication hole 46 of the cover while connecting them to each other. In this case, since the discharge tube 10 is provided outside the heat insulating housing 50, the guide rib 70 may be provided with a through-hole 72 through which the discharge tube 10 extends. Although the shape of the through-hole 72 may be a complete circle, the circular shape of the through- hole 72 makes it difficult to assemble the discharge tube 10; therefore, as shown in the figure, the through-hole 72 may be configured such that only one portion of the discharge tube 10 can be fixed.

In addition, the discharge tube 10 includes a plurality of fixing portions in order to fix the discharge tube 10 along the outer circumference of the heat insulating housing 50. This will be described later with reference to FIG. 5 to FIG. 7.

First, a first fixing portion 74, which fixes the discharge tube 10, may be formed along at least part of the circumference of the through-hole 72, and a second fixing portion 26, which fixes the discharge tube 10, may be formed in the stabilizer housing 20, such that it extends a predetermined length corresponding to the first fixing portion 74. That is, the discharge tube 10 is fixed using the first fixing portion 74, which is provided in the guide rib 70 of the cover 40, and the second fixing portion 26, which extends from the stabilizer housing 20. In this case, the end of the first fixing portion 74 and the end of the second fixing portion 26 that are butted against the discharge tube 10 may have a substantially semi-circular shape that corresponds to the cross-sectional shape of the discharge tube 10.

Here, the end of the above-mentioned second fixing portion 26 may be configured such that it becomes narrower in the direction toward the distal tip thereof. For example, the end of the second fixing portion 26 may be tapered. This is intended so that the end of the second fixing portion 26 can be bent by a predetermined angle such that it fixes the discharge tube 10, since the discharge tube 10 is pressed by the first fixing portion 74 of the guide rib 70 of the cover 40 when the cove 40 is assembled. Furthermore, there may also be provided a holder 80 having a third fixing portion 82, which fixes the discharge tube 10 to a portion of the heat insulating housing 50. This holder 80 may be pressed and fixed to the heat insulating housing 50. For example, as shown in FIG. 5, the third fixing portion 82 of the holder 80 is pressed and fixed to the heat insulating housing 50 along the side of the heat insulating housing 50, and fixes the discharge tube 10 to a predetermined portion.

In discharge lamps of the related art, the discharge tube is bonded to the base, or the like using a type of adhesive, which is referred to as “base cement,” in order to fix the discharge tube. Adding an adhesive was consequently a separate process that was required to fix the discharge tube, thereby consuming extensive time and cost during assembly. In addition, problems with the process of fixing the discharge tube using the adhesive are that the discharge tube may not be properly fixed by the amount of the adhesive used, the area to which the adhesive is applied, or the like, and that the discharge tube becomes loose as time passes. Accordingly, in order to solve the above-described problems, the discharge lamp of this embodiment more easily fixes the discharge lamp by fixing the discharge tube using the first, second and third fixing portions without using adhesive. Furthermore, the discharge lamp does not become loose and its initial fixing force can be maintained even as time passes.

In the meantime, the cover 40 is configured such that it surrounds the discharge tube 10, and is made of a transparent material such that light emitted from the discharge tube 10 can pass through it. The cover 40 is illustrated in detail in FIG. 7 and FIG. 8. FIG. 7 is a cross-sectional perspective view of the second cover as described above, and FIG. 8 is a cross-sectional perspective view of the first cover.

Referring to FIG. 7 and FIG. 8, the cover 40 may include a first cover 42 and a second cover 44, which are selectively connected to each other. For example, the cover 40 may include the first cover 42, which is connected to a portion that is adjacent to the base 30, and the second cover 42, which is connected to the first cover 42. When the cover 40 is implemented as two or more members, the ease of assembly may be improved over the case in which the cover is configured as an integral part. For example, it is possible to facilitate the assembly by first connecting the first cover 42 to the base 30 and then connecting the second cover 44 to the first cover 42.

In the case in which the first and second covers 42 and 44 are connected, the first diameter A of the joint that connects the first cover 42 and the second cover 44 to each other may be set to be greater than the second diameter B of the joint that connects the first cover 42 to the base 30. Due to this configuration, although the outer diameter of the discharge tube 10 is greater than the second diameter B as shown in FIG. 3, it is possible to insert the discharge tube 10 into the cover 40. Although it is difficult to insert the discharge tube 10, the diameter of which is greater than that of the opening of the cover 40, into the cover 40, when the cover 40 is provided integrally, it is possible to insert the greater discharge tube when the cover 40 is implemented as two or more members.

Returning to FIG. 7 and FIG. 8, a shield rib 48, which prevents light that is emitted from the discharge tube 10 from being directly emitted to the outside, may also be provided in the through-hole 72 of the cover 40. This is because the light from the discharge tube 10 may cause a problem, such as glaring, affecting a user when it is directly emitted through the through-hole 72.

The second cover 44 is fixed by fixing it to the first cover 42 using a fixing means such as a hook. However, a separate fixing means may also be provided in order to more securely fix the second cover 44. For example, the second cover 44 may be fixed by fixing it to the stabilizer housing 20. For this, the shield rib 48 may have an engagement-hole 49, and the stabilizer housing 20 may have an engagement boss 28 that corresponds to the engagement-hole 49. Accordingly, a worker can fix the second cover 44 by fastening a fastening member, such as a bolt, to the engagement boss 28 through the engagement-hole 49.

Describing discharge lamps having a cover of the related art, a silicone adhesive is used in order to fix the cover. However, such a fixing method using the adhesive exhibits poor workability, since it requires the additional process of applying and drying the adhesive as in the method of fixing a discharge tube of the related art. It also has a problem in that the cover is not easily separated in the case of future maintenance. Accordingly, when the cover is to be fixed, workability can be increased in the discharge lamp of this embodiment, since the cover can be fastened using a bolt or the like without using adhesive. Furthermore, the cover can be easily separated to conduct maintenance.

Although the exemplary embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A discharge lamp comprising:
a discharge tube;
a stabilizer housing provided in an inner space that is defined by the discharge tube, the stabilizer housing containing a stabilizer therein;
a cover surrounding the discharge tube;
a base connected to the stabilizer housing; and
a heat insulating means, wherein the heat insulating means prevents heat of the discharge tube from being transferred to the stabilizer.

2. The discharge lamp of claim 1, wherein the heat insulating means comprises a heat insulating housing, wherein the heat insulating housing surrounds at least a part of the stabilizer housing, such that at least one air gap is formed between the discharge tube and the stabilizer housing.

3. The discharge lamp of claim 2, wherein at least a part of the heat insulating housing and at least a part of the stabilizer housing are formed integrally.

4. The discharge lamp of claim 3, wherein the heat insulating housing comprises:
a first heat insulating housing formed integrally with the stabilizer housing; and
a second heat insulating housing connected to the first heat insulating housing.

5. The discharge lamp of claim of 3, wherein the stabilizer housing comprises:
a first stabilizer housing connected to the base; and
a second stabilizer housing connected to the first stabilizer housing.

6. The discharge lamp of claim of 5, wherein the heat insulating housing comprises:
a first heat insulating housing formed integrally with the first stabilizer housing; and
a second heat insulating housing connected to the first heat insulating housing.

7. The discharge lamp of claim 2, further comprising an air circulating means, wherein the air circulating means discharges air from a space between the heat insulating housing and the stabilizer housing to an outside and introduces external air to the space between the heat insulating housing and the stabilizer housing.

8. The discharge lamp of claim 7, wherein the air circulating means comprises:
a first opening formed in a portion of the heat insulating housing that is adjacent to the base; and
a second opening formed in another portion of the heat insulating housing, the second opening communicating with an outside.

9. The discharge lamp of claim 8, wherein the cover has a communication-hole communicating with the second opening.

10. The discharge lamp of claim 9, further comprising a guide rib on at least one of the cover and the heat insulating housing, wherein the guide rib guides a flow of air between the second opening and the communication-hole.

11. The discharge lamp of claim 10, wherein the guide rib has a through-hole through which the discharge tube extends.

12. The discharge lamp of claim 11, comprising:
a first fixing portion formed along at least a portion of the through-hole, the first fixing portion fixing the discharge tube; and
a second fixing portion formed in the stabilizer housing, the second fixing portion extending a predetermined length corresponding to the first fixing portion, thereby fixing the discharge tube.

13. The discharge lamp of claim 12, wherein one end of the second fixing portion becomes narrower in a direction toward a distal tip thereof, such that the second fixing portion is bent by a predetermined angle when fixing the discharge tube.

14. The discharge lamp of claim 12, further comprising a third fixing portion on a portion of the heat insulating housing, the third fixing portion fixing the discharge tube.

15. The discharge lamp of claim 14, wherein the holder is pressed and fixed to the heat insulating housing.

16. The discharge lamp of claim 11, further comprising a shield rib formed in the through-hole, the shield rib preventing light from the discharge tube from being directly emitted to an outside.

17. The discharge lamp of claim 16, wherein the shield rib has an engagement-hole, and the stabilizer housing has an engagement boss corresponding to the engagement-hole.

18. The discharge lamp of claim 1, wherein the cover comprises a first cover and a second cover, which are selectively connected to each other.

19. The discharge lamp of claim 18, wherein the first cover is connected to a portion that is adjacent to the base, and the second cover is connected to one end of the first cover.

20. The discharge lamp of claim 19, wherein a first diameter of a joint that connects the first cover and the second cover to each other is greater than a second diameter of a joint that connects the first cover to the base.
